(19) United States
(12) Patent Application Publication
(10) Pub. No.: US 2015/0227977 A1
(43) Pub. Date: Aug. 13, 2015

(54) GENERATING USER AUDIENCE GROUPS TO FACILITATE ADVERTISEMENT TARGETING

(71) Applicant: Facebook, Inc., Menlo Park, CA (US)

(72) Inventors: Jonathan Shottan, San Francisco, CA (US); Mathew Varghese, Los Altos, CA (US); Yi Huang, Pleasanton, CA (US); Peng Fan, Hayward, CA (US)

(21) Appl. No.: 14/177,300

(22) Filed: Feb. 11, 2014

(51) Int. Cl. G06Q 30/02; H04L 29/08

(52) U.S. Cl. CPC G06Q 30/0267; H04L 67/10

(57) ABSTRACT

An online system receives one or more business rules associated with a third party system that associates online system users with an audience group based on characteristics of the user. When an online system user interacts with content provided by the third party system via a client device, contextual information describing the interaction is communicated from the client device to the online system. By applying one or more business rules to the contextual information, the online system associates the user with one or more audience groups. The online system determines that the user is eligible to be presented with the advertisement based at least in part on the one or more audience groups associated with the user and the one or more of the audience groups specified by the advertiser associated with the advertisement. And if eligible, the online system provides the advertisement to the client device for presentation.

### BACKGROUND

This disclosure relates generally to online systems, and in particular to grouping online system users into one or more audience groups based on the users' interactions with third party websites and/or applications and one or more business rules.

An online system, such as a social networking system, allows its users to connect to and to communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for advertisers to increase awareness about products or services by presenting advertisements to online system users.

Presenting advertisements to users of an online system allows an advertiser to gain public attention for products or services and to persuade online system users to take an action regarding the advertiser's products, services, opinions, or causes. Generally, advertisers have various websites accessible to online system users in various locations. However, advertisers generally do not have access to information that an online system associates with users. This limitation of the information available to advertisers makes it difficult for advertisers to effectively identify advertisements to the online system for presentation to various users.

### SUMMARY

To allow a third party system to target advertisements more effectively to users of an online system, the online system generates one or more audience groups each including one or more users of the online system. For example, an audience group includes online system users having one or more common characteristics. In one embodiment, the third party system includes instructions or other code (e.g., a tracking pixel) in pages of a website or in a native application. When a client device executes the instructions or other code (e.g., when a browser renders a page of the website or when a native application renders content from the website), the client device communicates information identifying the user and describing the user's interactions with one or more of the pages to the online system. For example, the client device communicates identifiers of pages viewed (e.g., URLs), a type of interaction with the viewed pages, or other suitable information to the online system.

In some embodiments, the third party system provides one or more business rules to the online system describing criteria for including online system users in one or more audience groups. For example, one or more business rules identify user interactions with pages of a web site associated with users included in an audience group. Alternatively, the online system may determine one or more business rules for identifying user interactions included in one or more audience groups.

The online system may provide an audience widget to the third party system, which the third party system includes in pages or other content to communicate information to the online system. The audience widget is code or instructions (e.g., tracking pixel, JAVASCRIPT®, etc.), which is included on content provided by the third party system, when executed by a client device presenting content provided by the third party system causes the client device to communicate contextual information describing user interaction with the content to the online system. For example, the contextual information includes user identification information, an identifier of the content with which the user interacted, user interaction information, or some combination thereof. Additionally, in some embodiments, when a user accesses content associated with the third party system via the client device, the audience widget causes the third party system to communicate one or more business rules to the client device with instructions to provide the one or more business rules to the online system (e.g., in conjunction with the contextual information) or causes the third party system to directly communicate one or more business rules to the online system.

After receiving contextual information from the client, the online system determines one or more audience groups to associate with the user based in part on the business rules and a portion of the contextual information (e.g., an identifier of visited webpage, a type of interaction with the visited webpage). The online system associates a user profile maintained by the online system and associated with the user with the determined one or more audience groups. Subsequently, the third party system may target advertisements presented via the online system to various audience groups, allowing the third party system to more effectively present advertisements to online system users. For example, when the online system identifies an opportunity to present an advertisement via a client device, the online system determines user associated with the client device and selects an advertisement to provide to the client device based at least in part on audience groups associated with the user.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an interaction diagram of a method for assigning a user to one or more audience groups, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

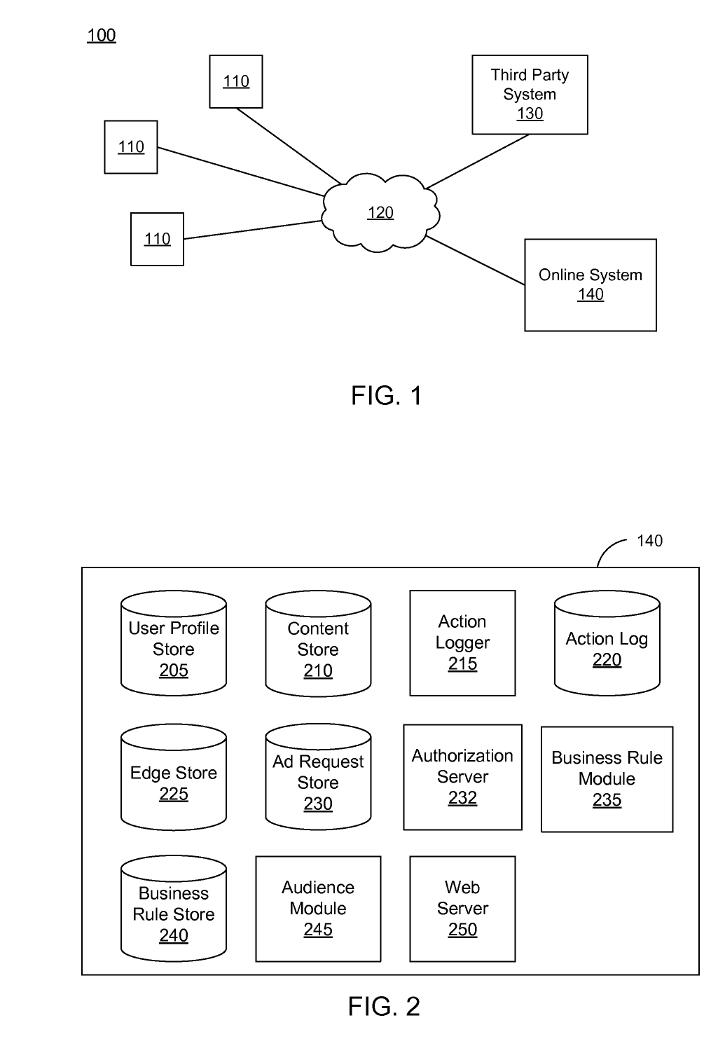

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, in some embodiments, the online system 140 is a social networking system, although the embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content (e.g., websites) or other information for presentation via a client device 110. A third party system 130 may also communicate information to the online system 140, such as advertisements, content, or information about an application provided by the third party system 130. In some embodiments, the third party system 130 is on the same web domain as the online system 140. Alternatively, the third party system 130 may be on a separate web domain than the online system 140, and is maintained or operated by an entity that is distinct, separate, and/or independent from the online system 140.

FIG. 2 is a block diagram of an architecture of the online system 140, which may be a social networking system in some embodiments. The online system 140 shown in FIG. 2 includes a user profile store 205, a content store 210, an action logger 215, an action log 220, an edge store 225, an ad request store 230, an authorization server 232, a business rule module 235, a business rule store 240, an audience module 245, and a web server 250. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

Additionally, in some embodiments, user profiles may include audience information that identifies users as being part of one or more audience groups. An audience group is group of one or more users having at least one common characteristic. For example, an audience group includes users of the online system 140 that each performed a specific type of interaction with content. Examples of interactions include a user visiting a particular page or content, a number of times a user visits a particular page of a website, a user accessing a particular advertisement, a user performing a specified type of action on an application associated with a third party system 130, etc. In one embodiment, an audience group identifier is stored in the user profile store 205 and associated with user identifying information of users in the corresponding audience group. An audience group identifier may also be included in a user's user profile to indicate that the user is included in the audience group.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the online system 140. In one embodiment, objects in the content store 210 represent single pieces of content, or content “items.” Hence, social networking system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's interest for an object, interest, or other user in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the online system 140 if the advertisement is presented to a user, if the advertisement receives a user interaction, or based on any other suitable condition. For example, the bid amount specifies a monetary amount that the online system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria.

In some embodiments, the targeting criteria may identify one or more audience groups to present an advertisement to users included in one or more of the identified audience groups. As noted above, an audience group describes groups of users having one or more common characteristics. For example, an audience group includes users having performed one or more interactions with content indicating an interest in visiting Paris rather than visiting London; including information identifying the audience group as targeting criteria allows an advertiser to target advertisements associated with Paris to users in the audience group to increase the likelihood of users interacting with the advertisements. Hence, targeting criteria allow an advertiser to identify users having specific characteristics, allowing the advertiser to present users with advertisements in which the user is more likely to have an interest.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The authorization server 232 enforces one or more privacy settings of the users of the online system 140. A privacy setting of a user determines how particular information associated with a user may be shared. In some embodiments, one or more privacy settings are stored in the user profile of a user in the user profile store 205 or are stored in the authorization server 232 and associated with a user profile. A privacy setting may specify whether the online system 140 maintains an association of the user with a one or more audience groups, allowing the user to opt out of advertisement targeting based on audience group membership; for example, the privacy setting allows a user to remove the user's identification information from the audience group and/or prevent the user's user identification information from being included in the audience group. In one embodiment, a privacy setting specifies particular information associated with a user and identifies the entity or entities with whom the specified information may be shared. Examples of entities with which information can be shared include other users, applications, third party systems 130 or any entity that can potentially access the information. Examples of information that may be shared by a user include user profile information (e.g., profile photo, phone numbers associated with the user, location, etc.), connections between the user and additional users, and actions taken by the user (e.g., adding a connection, changing user profile information).

The privacy setting specification may be provided at different levels of granularity. In one embodiment, a privacy setting may identify specific information to be shared with other users. For example, the privacy setting identifies a work phone number or a specific set of related information, such as, personal information including profile photo, home phone number, and status. Alternatively, the privacy setting may apply to all the information associated with the user. The set of entities capable of accessing particular information may also be specified at various levels of granularity. Various sets of entities with which information can be shared may include, for example, all users connected to the user, a set of users connected to the user, additional users connected to users connected to the user, all applications, all third party systems 130, specific third party systems 130, or other suitable entities.

In one embodiment, a privacy setting enumerates entities capable of accessing identified information or enumerates types of information capable of presentation to different entities. For example, the user specifies types of actions that are communicated to other users or are communicated to a specified group of users. Alternatively, the user may specify types of actions or other information that is not published or presented to other users.

The authorization server 232 includes logic to determine if certain information associated with a user may be accessed by users connected to the user, a third-party system 130 and/or other applications and entities. For example, a third-party system 130 that attempts to access a user's comment about a uniform resource locator (URL) associated with the third-party system 130 must get authorization from the authorization server 232 to access information associated with the user. Based on the user's privacy settings, the authorization server 232 determines if another user, a third-party system 130, an application, or another entity is allowed to access information associated with the user, including information about actions taken by the user. For example, the authorization server 232 uses a user's privacy setting to determine if the user's comment about a URL associated with the third-party system 130 may be presented to the third-party system 130 or may be presented to another user. This enables a user's privacy setting to specify which other entities or users are allowed to receive data about the user's actions or other data associated with the user.

One or more business rules are used by the online system 140 to associate a user with one or more audience groups. A business rule specifies criteria for generating one or more audience groups including one or more users of an online system. In one embodiment, one or more business rules identify characteristics of users included in an audience group. For example, business rules associate one or more locations with an audience group, so users are included in an audience group based on a location of the user or based on a location associated with content with which the user interacts (e.g., a website for a hotel in Paris vs. a website for a hotel in London). Other examples of business rules include a user in an audience group based on a time elapsed between a current time and a time when a user performed a specific type of interaction, based on types of actions performed by the user with content provided by a third party system 130 (e.g., viewing a page from a website, clicking, interactions with an application, etc.), based on language of content presented to the user (e.g., a French version of website versus an English version of the website), or any other suitable criteria.

The business rule module 235 simplifies generation of one or more business rules. In one embodiment, the business rule module 235 provides an audience widget to one or more third party systems 130. For example, the audience widget is code or instructions for inclusion in content provided by the third party system 130 for execution by a client device 110 when received along with the content (e.g., a tracking pixel, JAVASCRIPT®, etc.). When the client device 110 executes the code or instructions comprising the audience widget, the client device 110 communicates contextual information describing interaction with content via the client device 110 to the online system 140 or to a third party system 130. In some embodiments, the audience widget may be created using a software development kit (SDK) provided to third party systems 130 by the online system 140. And in some instances, the online system 140 charges a third party system 130 a fee for using the SDK, allowing the online system 140 to receive additional compensation from the third party system 130.

For example, a third party system 130 includes the audience widget in one or more web pages provided by the third party system 130. When a client device 110 requests a web page including the audience widget from the third party system, the audience widget communicates with the third party system 130, which sends a redirect request 110 to the client device 110. When the client device 110 receives the redirect request from the third party system 130, the client device 110 communicates the contextual information to the online system 140. In alternate embodiments, the logic of which interaction to capture and when to provide the contextual information to the online system 140 is executed by the audience widget on the client device 110. For example, due to one or more interactions between the user device 110 and the third party system 130, the audience widget collects contextual information and causes the user device 110 to provide the collected contextual information to the online system 140. In some embodiments the audience widget may cause the third party system 130 to communicate one or more business rules along with the redirect request to the client device 110, which communicates the one or more business rules to the online system 140 along with the contextual information.

The contextual information provided to the online system 140 includes user identification information associated with the user of the client device 110 and information describing interaction between the user and the content provided via the client device 110. The user identification information corresponds to a user profile associated with the user by the online system 140. In some embodiments, the user identification information is used by an application associated with the online system 140 and executing on the client device 110. Additionally, in some embodiments, the user identification information may include a cookie that identifies the client device 110, or an application executing on the client device 110 used to access content, to the online system 140. The information describing interaction between the user and the provided content includes information identifying the content presented via a client device 110 (e.g., an identifier of a web page presented by the client device 110, such as a URL, an identifier associated with the third party system 130 providing the content, information describing the content, etc.). Additionally, the information describing interaction between the user and the provided content describes interactions between the user and the presented content (e.g., web page or application). For example, the information describes a type of action performed by the user, content with which the user interacted (e.g., describing whether a user looked at and/or bought an item from a website, looked at and/or booked a room via a website, etc.), or other suitable information describing interaction with the content. In some embodiments, the information describing interaction between the user and the provided content may be based on one or more custom parameters that control types of information collected by the user device 110 and provided to the online system 140. For example, a custom parameter may track if a certain event occurs in a certain location.

In some embodiments, the business rule module 235 provides a user interface to the third party system 130 to specify one or more business rules and communicate the one or more business rules to the online system 140. In some embodiments, a third party system 130 administrator may login to the online system 140 and create, edit, delete, or otherwise modify one or more business rules via the user interface. In other embodiments, the third party system 130 generates the one or more business rules and provides at least one of the generated business rules to the online system 140 using any suitable method.

The business rule store 240 maintains one or more business rules associated with one or more third party systems 130. As described above, a business rule identifies one or more types of interactions associated with users or another suitable characteristic associated with users included in an audience group associated with the business rule. For example, the business rule store 240 includes an identifier associated with a third party system 130 and one or more business rules associated with the identifier, simplifying retrieval of business rules associated with a third party system 130. In some embodiments, a business rule may be triggered by information received based on one or more custom parameters. For example, a business rule causes the online system 140 to place a user in custom audience A if the user is associated with a particular city and check in date. In some embodiments, information identifying content (e.g., uniform resource locators) associated with business rules, such as content provided by a third party system 130 and associated with the business rules, is also included in the business rule store 240.

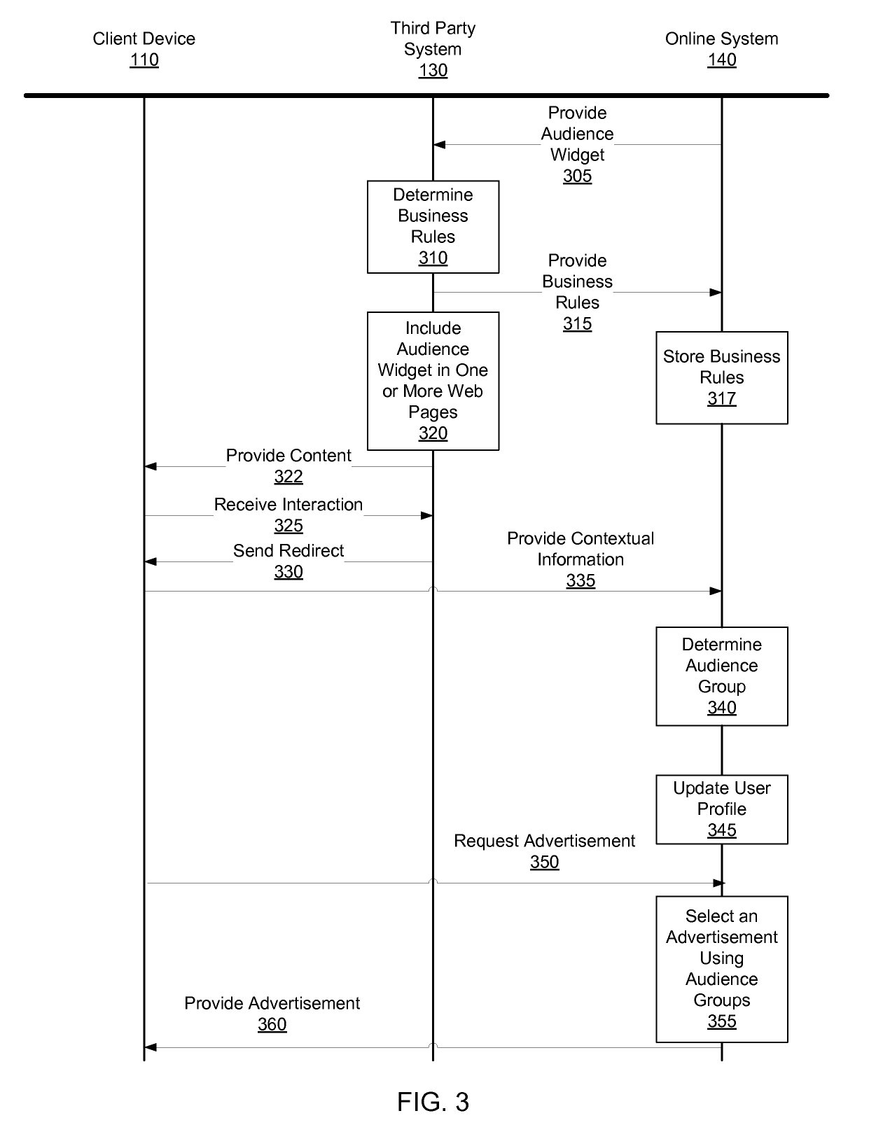

The audience module 245 determines audience groups to associate with a user based on a portion of the contextual information received from the client device 110 and one or more business rules. As further described below in conjunction with FIG. 3, the audience module 245 extracts user identification information and information describing user interaction from the contextual information. For example, the audience module 245 extracts user identifying information associated with a user of the online system 140, an identifier associated with a third party system 130 providing content, an identifier of the content, and information describing interaction between the user and the content. The audience module 245 retrieves one or more business rules from the business rule store 240 based on the contextual information and applies the retrieved business rules to the information describing user interaction. For example, business rules associated with a third party system 130 identified by the contextual information are retrieved from the business rule store 240. Additionally, one or more privacy settings associated with the user corresponding to the extracted user identifying information are retrieved from the authorization server 232, and the audience module 245 associates the user with one or more audience groups based on the privacy settings, the information describing the user's interaction with content, and the business rules For example, if a business rule associates a user to audience group B if the user views content in English, and the information describing user interaction with content indicates the user views content from a third party system in English, the audience module 245 associates the user with audience group B. Association of a user with one or more audience groups is further described below in conjunction with FIG. 3.

The web server 250 links the online system 140 via the network 120 to the one or more client devices 110, as well as to the one or more third party systems 130. The web server 250 serves web pages, as well as other content, such as JAVA®, FLASH®, XML and so forth. The web server 250 may receive and route messages between the online system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that are stored in the content store 210. Additionally, the web server 250 may provide application programming interface (API) functionality to send data directly to native client device operating systems, such as IOS®, ANDROID™, WEBOS® or BlackberryOS.

Associating a User with an Audience Group

FIG. 3 is an interaction diagram of one embodiment of a method for assigning a user to one or more audience groups. In various embodiments, the method may include different and/or additional steps than those described in conjunction with FIG. 3. Additionally, in some embodiments, the steps may be performed in a different order than described in conjunction with FIG. 3.

In one embodiment, the online system 140 provides 305 an audience widget to a third party system 130. As described above in conjunction with FIG. 2, the audience widget comprises code or instructions for inclusion in content provided by the third party system 130. When a client device 110 presents content including the audience widget, the audience widget is executed and information specified by the audience widget is communicated to the third party system 130 or to the online system 140. In some embodiments, the information specified by the audience widget is determined by one or more custom parameters, as described above in conjunction with FIG. 2.

The third party system 130 determines 310 one or more business rules each identifying one or more characteristics of users included in an audience group. In some embodiments, the third party system 130 uses a user interface provided by the online system 140 to create, edit, or delete one or more business rules. For example, the third party system 130 is be associated with a worldwide chain of hotels with locations in different countries, so the third party system 130 creates a business rule including users in audience group A if they view content from the third party system 130 associated with a Paris location of the hotel chain and a business rule associating users with audience group B if they view content associated with the London location of the hotel chain. Additionally, in some embodiments, determined business rules may are satisfied if one or more custom parameters are met.

In some embodiments, the third party system 130 provides 315 the one or more business rules to the online system 140, which stores 317 the business rules. Alternatively, the third party system 130 determines 310 the business rules and includes information describing one or more of the business rules in the audience widget. Hence, execution of the audience widget communicates the business rules, along with additional information provided to the online system 140.

The third party system 130 includes 320 the audience widget to one or more web pages or other content provided by the third party system 130. For example, the third party system 130 includes 320 the audience widget in web pages that comprise a website maintained by the third party system 130. The third party system 130 may include 320 the audience widget in certain web pages or other types of content to limit the content provided by the third party system 130 for which contextual information is communicated to the online system 140. Alternatively, the third party system 130 includes 320 the audience widget in each web page or portion of content that comprises a website or other collection of content provided by the third party system 130. For example, the third party system 130 may add the audience widget to select pages of a website (e.g., a home page), may add the audience widget to all pages of a website, may add the audience widget to pages of its websites accessible to the public, or may add the audience widget to an application.

Content, such as a web page, maintained by the third party system 130 and including the audience widget is provided 322 to a client device 110 associated with a user of the online system 140. When the client device 110 receives 325 an interaction with the content by the user, information describing the interaction is communicated to the third party system 130 user interaction is communicated to the third party system 130 via the network 120. For example, a user requests presentation of a web page from the third party system 130 including the audience widget via the client device 110. Other examples of received interaction with content including the audience widget includes the user making a purchase of a product or service, the user providing a comment on presented content, the user requesting additional content, or a user indicating a preference for presented content.

In some embodiments, when the audience widget is executed by the client device 110, information is sent to the third party system 130, which sends 330 a redirect request to the client device 110. The redirect request identifies a network address associated with the online system 140, causing the client device 110 to provide 335 contextual information to the online system 140 when the redirect request is received by the client device 110. The contextual information includes user identification information and information describing the user interaction with the content presented by the client device 110, as described above in conjunction with FIG. 2. For example, the information describing user interaction with the content includes an identifier of the content provided 322 by the third party system 130 (e.g., a uniform resource locator of the content), information identifying the third party system 130, information describing a type of interaction between the user and the content, or some combination thereof.

Based on the contextual information and one or more business rules associated with the third party system 130, the online system 140 determines 340 one or more audience groups to associate with the user. Additionally, the online system 140 may retrieve one or more privacy settings associated with the user and apply the one or more privacy settings associated with the user when determining 340 the one or more audience groups to associate with the user. For example, the online system 140 identifies user identifying information from the contextual information and retrieves one or more privacy settings based on the user identifying information; similarly, the online system 140 retrieves one or more business rules associated with the third party system 130 based on information identifying the third party system 130 from the contextual information. The online system 140 then applies the one or more business rules, in accordance with the user's privacy settings, to information describing user interaction with content identified from the contextual information to determine one or more audience groups to be associated with the user. For example, the presented content is associated with the Paris location of a hotel chain, and one or more business rules cause the use to be grouped into audience group A. The online system 140 updates 345 the user profile associated with the user to associate the user with an audience group (audience group A in the preceding example) and stores information identifying the user in association with an identifier corresponding to audience group (audience group A in the preceding example). If one or more privacy settings associated with the user specify that the user's identification information is not to be included in information identifying one or more audience groups, information identifying the user is not associated with one or more audience groups.

After associating the user with one or more audience groups, the online system 140 identifies an opportunity to present one or more advertisements to the user via the client device 110 or some other client device associated with the user. For example, the online system 140 receives 350 a request from the client device 110 or from another device associated with the user to present one or more advertisements to the user.

The online system 140 selects 355 an advertisement based at least in part on the audience group associated with the user and audience groups associated with one or more advertisements. For example, the online system 140 may determine whether the user is eligible to be presented with an advertisement based on one or more audience groups associated with the user and targeting criteria associated with the advertisement that specifies an audience group matching an audience group including the user.

The online system 140 may select candidate advertisements having targeting criteria specifying at least one audience group matching an audience group including the user and determine an expected value for each candidate advertisement based on bid amounts associated with each candidate advertisement and a likelihood of the user accessing a candidate advertisement. To estimate the likelihood that a user will access a candidate advertisement, the online system 140 may use the user's affinities for targeting criteria, including audience information, associated with the candidate advertisement or with other objects associated with the candidate advertisement. The candidate advertisements are ranked based on their expected values, and a candidate advertisement is selected based at least in part on the ranking. For example, the candidate advertisement having the highest expected value is selected. The online system 140 then provides 360 the advertisement to the client device 110 or to another device associated with the user for presentation to the user.

### Alternate Embodiments

With reference to FIG. 3, in some embodiments, the client device 110 includes data or instructions for identifying information to capture and for identifying information, such as contextual information, to communicate to the online system 140. For example, the client device 110 requests content from the third party system 130, which provides content to the client device 110 including an audience widget or other instructions identifying interactions with the client device 110 to communicate from the client device 110 to the third party system 130, rather than the third party system 130 providing 322 content to the client device 110, receiving 325 information describing an interaction with the provided content, and sending 330 a redirect request to the client device 110 as shown in the example of FIG. 3. The user device 110 may receive one or more interactions with content provided by the third party system 130, and based on information specified the audience widget, the user device 110 provide 335 contextual information describing the received interactions to the online system 140.

### Summary

The foregoing description of the embodiments have been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the embodiments, which is set forth in the following claims.

What is claimed is:

1. A method comprising:
receiving contextual information from a client device associated with a user of an online system, the contextual information including information identifying the user and information describing an interaction between the user and content associated with a third party system;
determining one or more audience groups associated with the user based at least in part on one or more business rules and a portion of the contextual information, the one or more business rules specifying criteria for whether a user is to be included in an audience group, each audience group including one or more users of the online system;
determining that the user is eligible to be presented with the advertisement based at least in part on the one or more audience groups associated with the user and the one or more of the audience groups specified by the advertiser associated with the advertisement; and
responsive to the determining, providing the advertisement to the client device for presentation if the user is determined to be eligible to be presented with the advertisement.

2. The method of claim 1, further comprising:
receiving one or more business rules associated with a third party system, wherein the one or more business rules are received from the third party system.

3. The method of claim 2, further comprising:
providing an interface to the third party system;
receiving information from the third party system via the interface; and
generating the one or more business rules based at least in part on the received information.

4. The method of claim 1, wherein a business rule specifies one or more characteristics associated with an audience group.

5. The method of claim 1, wherein determining one or more audience groups associated with the user based at least in part on the one or more business rules and a portion of the contextual information comprises:
identifying one or more characteristics associated with the user based on the portion of the contextual information; and
associating the user with one or more audience groups associated with at least one business rule specifying a characteristic matching an identified characteristic associated with the user.

6. The method of claim 4, wherein a characteristic associated with the audience group comprises a type of interaction with content provided by the third party system.

7. The method of claim 6, wherein the type of interaction is selected from a group consisting of: viewing the content provided by the third party system, purchasing a product or service identified by the content, providing a comment on the content, requesting additional content, indicating a preference for the content, and any combination thereof.

8. The method of claim 1, wherein the contextual information further identifies the content associated with the third party system.

9. The method of claim 1, wherein receiving contextual information from the client device associated with the user of the online system comprises:
receiving the contextual information responsive to the client device executing one or more instructions included in content presented to the user to communicate the contextual information to the online system.

10. A method comprising:
receiving contextual information from a client device associated with a user of an online system, the contextual information including information identifying the user and information describing interaction between the user and content associated with a third party system;
determining one or more audience groups associated with the user based at least in part on one or more business rules and a portion of the contextual information, the one or more business rules specifying criteria for whether a user is to be included in an audience group, each audience group including one or more users of the online system; and
storing information associating the user with the determined one or more audience groups.

11. The method of claim 10, wherein storing information associating the user with the determined one or more audience groups comprises:
storing information identifying the determined one or more audience groups in a user profile associated with the user.

12. The method of claim 10, wherein storing information associating the user with the determined one or more audience groups comprises:
storing information identifying the user in association with identifiers associated with each of the determined one or more audience groups.

13. The method of claim 10, further comprising:
determining that the user is eligible to be presented with the advertisement based at least in part on the one or more audience groups associated with the user and the one or more of the audience groups specified by the advertiser associated with the advertisement; and
responsive to the determining, providing the advertisement to the client device for presentation if the user is determined to be eligible to be presented with the advertisement.

14. The method of claim 10, further comprising:
receiving one or more business rules associated with a third party system a business rule specifies one or more characteristics associated with an audience group.

15. The method of claim 10, wherein determining one or more audience groups associated with the user based at least in part on the one or more business rules and a portion of the contextual information comprises:
identifying one or more characteristics associated with the user based on the portion of the contextual information; and
associating the user with one or more audience groups associated with at least one business rule specifying a characteristic matching an identified characteristic associated with the user.

16. The method of claim 14, wherein a characteristic associated with the audience group comprises a type of interaction with content provided by the third party system.

17. The method of claim 16, wherein the type of interaction is selected from a group consisting of: viewing the content provided by the third party system, purchasing a product or service identified by the content, providing a comment on the content, requesting additional content, indicating a preference for the content, and any combination thereof.

18. A computer program product comprising a computer-readable storage medium having instructions encoded thereon that, when executed by a processor, cause the processor to:
receive contextual information from a client device associated with a user of an online system, the contextual information including information identifying the user and information describing interaction between the user and content associated with a third party system;
determine one or more audience groups associated with the user based at least in part on one or more business rules and a portion of the contextual information, the one or more business rules specify criteria for whether a user is to be included in an audience group, each audience group including one or more users of the online system; and
store information associating the user with the determined one or more audience groups.

19. The computer program product of claim 18, wherein the instructions, when executed by a processor, further cause the processor to:
determine that the user is eligible to be presented with the advertisement based at least in part on the one or more audience groups associated with the user and the one or more of the audience groups specified by the advertiser associated with the advertisement; and
responsive to the determining, provide the advertisement to the client device for presentation if the user is determined to be eligible to be presented with the advertisement.

20. The computer program product of claim 18, wherein determine one or more audience groups associated with the user based at least in part on the one or more business rules and a portion of the contextual information comprises:
identify one or more characteristics associated with the user based on the portion of the contextual information; and
associate the user with one or more audience groups associated with at least one business rule specifying a characteristic matching an identified characteristic associated with the user.
